(19) United States
(12) Patent Application Publication
(10) Pub. No.: US 2021/0294058 A1
(43) Pub. Date: Sep. 23, 2021

(54) MULTI-ZONED HIGH-CAPACITY SPLICE ORGANIZER TRAY

(71) Applicant: Corning Research & Development Corporation, Corning, NY (US)

(72) Inventors: William George Allen, Austin, TX (US); Thomas Edward Bludau, Fresno, CA (US)

(21) Appl. No.: 17/204,624

(22) Filed: Mar. 17, 2021

Related U.S. Application Data
(60) Provisional application No. 62/991,018, filed on Mar. 17, 2020.

(51) Int. Cl. G02B 6/44

(52) U.S. Cl. CPC G02B 6/4454

(57) ABSTRACT

A multi-zoned, high-capacity, splice organizer tray includes a base extending longitudinally from a first end to a second end such that the base includes a plurality of cable entrances at the first end of the splice organizer tray and a first interconnection layer disposed on the base. The first interconnection layer includes a first optical component insert and a first repositionable mezzanine and a second interconnection layer substantially aligned horizontally with the first interconnection layer. The second interconnection layer includes a second optical component insert and a second repositionable mezzanine. The optical fiber organizer tray is stackable and comprises a plurality of horizontal fiber zones and a plurality of vertical fiber zones.

### CROSS-REFERENCE To RELATED APPLICATION

This application claims priority to U.S. Patent Application No. 62/991,018, filed Mar. 17, 2020, the content of which is incorporated herein by reference in its entirety.

### BACKGROUND

The present disclosure relates to multi-zoned, high-capacity splice organizer trays. In particular, the splice organizer trays disclosed herein include a plurality of horizontal and vertical fiber zones for storing and splicing optical fiber.

Telecommunication cables are used for distributing data across vast networks. Modern communication and data networks rely on fiber optic transmission lines or cables due to their high speed and low attenuation characteristics. As these fiber optic cables are routed across networks, it is necessary to periodically open the cable and splice or tap into the cable so that data may be distributed to “branches” of the network. The branches may be further distributed until the network reaches individual homes, businesses, offices, and so on. The distributed lines are often referred to as drop lines. At each fiber access point where the cable is opened, it is necessary to provide some type of enclosure to protect the cable (and potentially unjacketed fiber) and allow easy and repeated access to the cable. These enclosures need to provide features to store the fiber optic lines as well as allow for the interconnection between the incoming and outgoing fiber optic lines.

The purpose and configuration of the enclosure will vary depending on where the enclosure is located in a network. When an enclosure is used to interconnect distribution lines, the number of splices that can be made in the enclosure is a factor in determining which enclosure and which accessories within the enclosure are used. Frequently, telecommunication carriers want to use the smallest enclosure that can accommodate the needed number of splices due to factors like the cost of the enclosure, cost of installation, as well as aesthetics for above grade installations. At another point in the network an enclosure can be used to distribute signals from a few optical fibers to many optical fibers through the use of optical splitters. While in another application, an enclosure may also contain a termination field for interconnecting optical fiber connectors.

As networks expand telecommunication carriers may want to add a cable to an existing fiber access point to increase capacity of a portion of the network or bring service to an area which did not have high speed, gigabit service previously. In order to do this the optical fiber interconnection capacity of enclosures at these fiber access points needs to increase.

Splice organizer trays are a primary component used within communication enclosures to house optical fiber interconnection components such as optical fiber splices, optical splitters and the like. In order to increase the number of optical fiber splices within an enclosure, conventional practice is to simply add another tray, but this may not be possible due to volume constraints of the enclosure, installation requirements (e.g. slack storage requirements), the type of tray being used as well as the design criteria of the splice organizer tray itself such as splice capacity, tray dimensions, etc. Moreover, due to the expected and continued growth in the volume of data transmitted over fiber optic networks, the need for adding more capacity in trays has grown considerably. Fiber optic cables having higher fiber counts are now more common, and often more time and effort is required to route, store, and splice optical fibers. Thus, there are various needs for improved splice organizer trays, and particularly splice organizer trays that can support the breadth of optical fiber interconnection and capacity expansion.

### SUMMARY

The present disclosure relates to multi-zoned, high-capacity splice organizer trays. In one exemplary embodiment, a multi-zoned, high-capacity splice organizer tray includes a tray body, having a base that extends longitudinally from a first end to a second end, wherein the base includes a plurality of cable entrances at the first end; a first interconnection layer disposed on the base, comprising a first optical component insert and a first repositionable mezzanine, a second interconnection layer substantially aligned horizontally with the first interconnection layer, the second interconnection layer comprising a second optical component insert and a second repositionable mezzanine, wherein defined in the tray is a plurality of horizontal fiber zones for storage of fiber optic cables routed through the plurality of cable entrances, wherein each horizontal fiber zone is bounded by a divider and wherein defined in the tray is a plurality of vertical fiber zones, and wherein each vertical fiber zone is bounded by a plurality of vertically oriented tabs arranged at different heights along the side wall of the tray.

The above summary is not intended to describe each illustrated embodiment or every implementation. The figures and the detailed description that follows more particularly exemplify these embodiments.

### BRIEF DESCRIPTION OF THE DRAWINGS

The present disclosure will be further described with reference to the accompanying drawings:

FIG. 1A is an isometric view of a multi-zoned, high-capacity splice organizer tray, according to an embodiment disclosed herein.

FIG. 1B is a top view of the multi-zoned, high-capacity splice organizer tray shown in FIG. 1A.

FIG. 2 is an isometric view of a base included in the multi-zoned, high-capacity splice organizer tray shown in FIGS. 1A and 1B.

FIGS. 3A-3C illustrate various stages of assembly for the multi-zoned, high-capacity splice organizer tray with cables or cable subunits, including ribbon fiber.

FIG. 4 is a cross-sectional view of a multi-zoned, high-capacity splice organizer tray after positioning of fibers into a fiber storage area and a first vertical zone.

FIG. 5 is a cross-sectional view of a multi-zoned, high-capacity splice organizer tray after positioning of spliced fibers into a first vertical zone and a second vertical zone.

Additional features and advantages will be set forth in the Specification and the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### DETAILED DESCRIPTION

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not limited to the following described exemplary embodiments, but are to be controlled by the limitations set forth in the claims.

In the following description, reference is made to the accompanying drawings that form a part hereof and in which are shown by way of illustration. It is to be understood that other embodiments are contemplated and may be made without departing from the scope or spirit of the present disclosure. The following detailed description, therefore, is not to be taken in a limiting sense.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “coupled with” or “in contact with” another element, component or layer, it can be directly on, directly coupled with, in direct contact with, or intervening elements, components or layers may be on, connected, coupled or in contact with the particular element, component or layer, for example. When an element, component or layer for example is referred to as being “directly on,” “directly coupled with,” or “directly in contact with” another element, there are no intervening elements, components or layers for example.

The multi-zoned, high-capacity, splice organizer tray (hereinafter “splice organizer tray”) described herein is a configurable tray that can be used to interconnect optical fibers, particularly ribbon fiber, as used in various types of fiber optic cables or cable subunits. The optical fibers, however, could be in the form of individual 250 □m coated optical fibers, 900 □m buffer coated optical fibers, small diameter jacketed cables, optical fibers contained in buffer tubes, or optical ribbon fibers.

By providing a number of zones, the splice organizer tray basically subdivides fiber, allowing for better organization and increased density of both stored and fiber optic splicing. Better organization, in turn, contributes to improved efficiencies, particularly during installation. As will be apparent from the following description, the splice organizer tray provides various features that allow for direct routing of cables or cable subunits to the splice tray. Accordingly, providing multiple zones in a splice organizer tray in accordance with the embodiments disclosed herein provides several advantages, which are not to be construed as limiting.

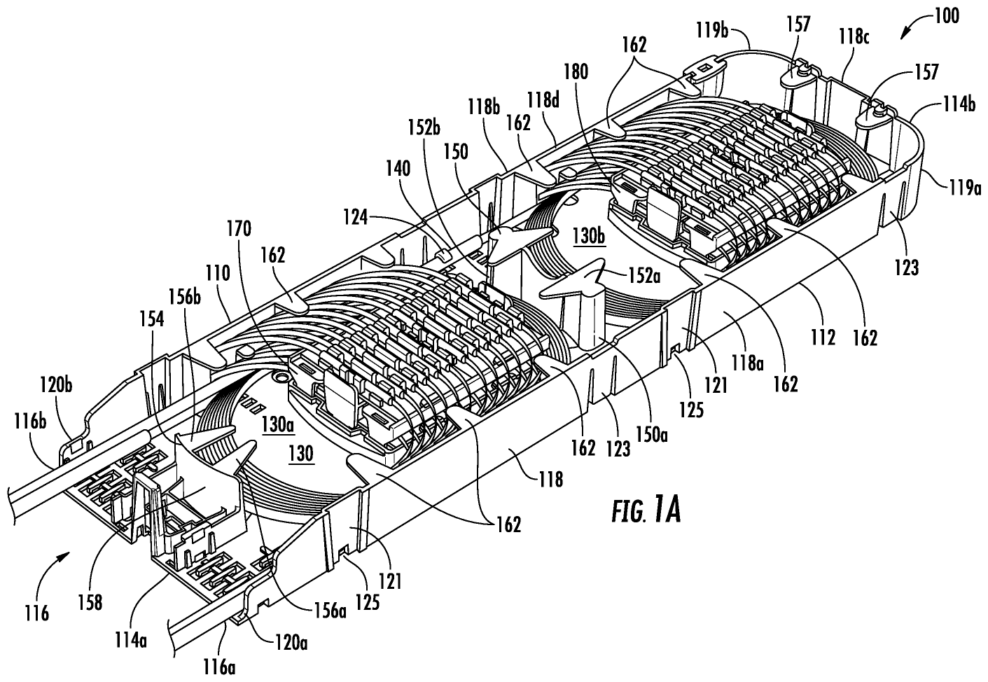

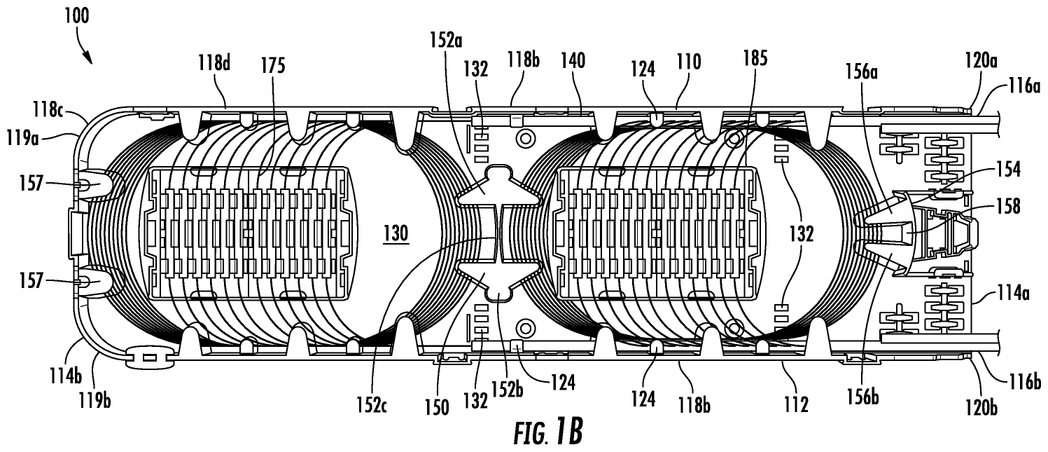

FIGS. 1A-3C show a splice organizer tray 100 in accordance with an embodiment disclosed herein. The splice organizer tray is preferably configured for positioning within various types of enclosures. A plurality of splice organizer trays can also be stacked or positioned adjacently with respect to one another, depending upon size limitations of the enclosure.

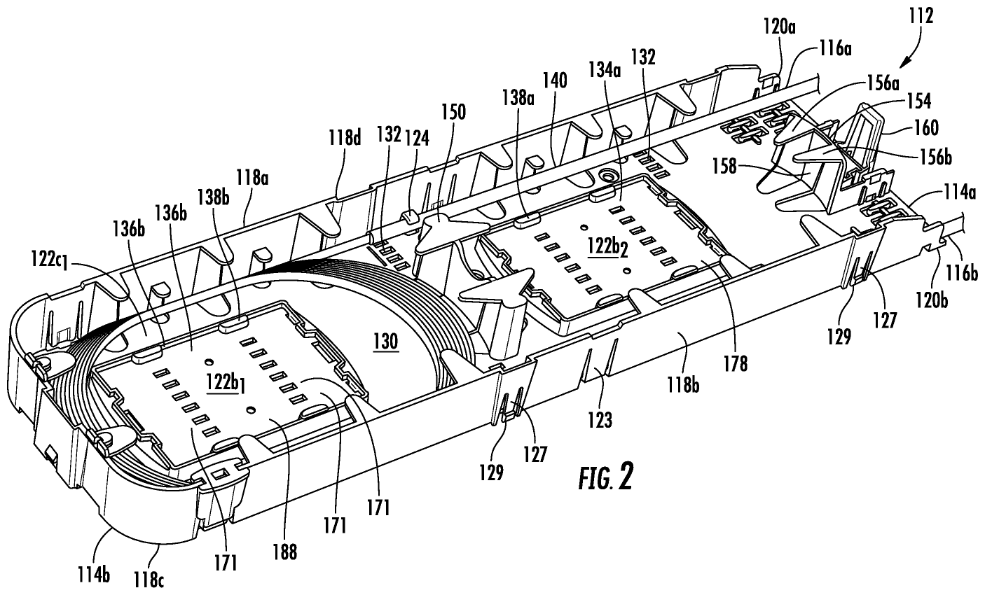

FIGS. 1A and 1B show the splice organizer tray 100 fully assembled with stored fiber and spliced fiber in various zones, as will be further described. Referring particularly to FIGS. 1A, 1B, and 2, the splice organizer tray 100 includes a tray body 110 having a bottom tray or base 112, which extends longitudinally from a first end 114a to a second end 114b. The base 112 preferably includes a plurality of cable entrances 116. In this embodiment of the splice organizer tray, two cable entrances 116a, 116b are included. Each cable entrance is configured to receive a plurality of cables or cable subunits 2, which include optical fiber. Each cable or cable subunit 2,4, is held in the splice organizer tray 100 by retention tabs 124. Moreover, a plurality of tie down areas 117a, 117b can be provided at each cable entrance 116a, 116b to strain relieve cables entering and exiting the splice organizer tray.

As shown particularly in FIG. 2, the base 112 additionally includes a side wall 118 extending upwardly from the base from a first corner 120a at the first end of the base around the second end of the base to a second corner 120b at the first end of the base. The side wall 118 preferably includes two wall sections 118a, 118b, which oppose each other, and a curved wall 118c at the second end 114b of the base. The curved wall 118c includes radiused wall sections 119a, 119b that are integral with the two wall sections 118a, 118b.

The splice organizer tray 100 can mounted to an enclosure or another tray by a connection mechanism, which can be integrally or non-integrally formed with the splice organizer tray. In preferred configurations, each wall section 118a, 118b, 118c has at least one connection mechanism for connection to an enclosure or another tray. Connection mechanisms may be configured as a slot 121 or a tang 123, 127, 131 which may include a notch 125 or protrusion 129, 133 that mates with a corresponding slot or tang on a mating tray or enclosure. In addition, the splice organizer tray can include a latch 160 at the first end 114a for mounting purposes.

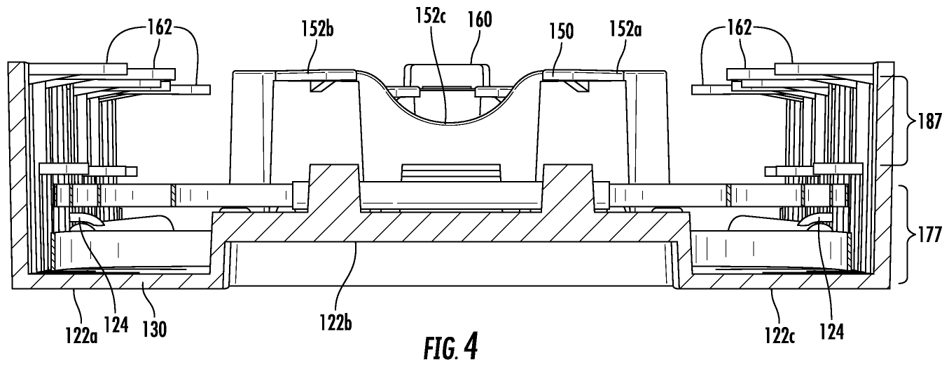

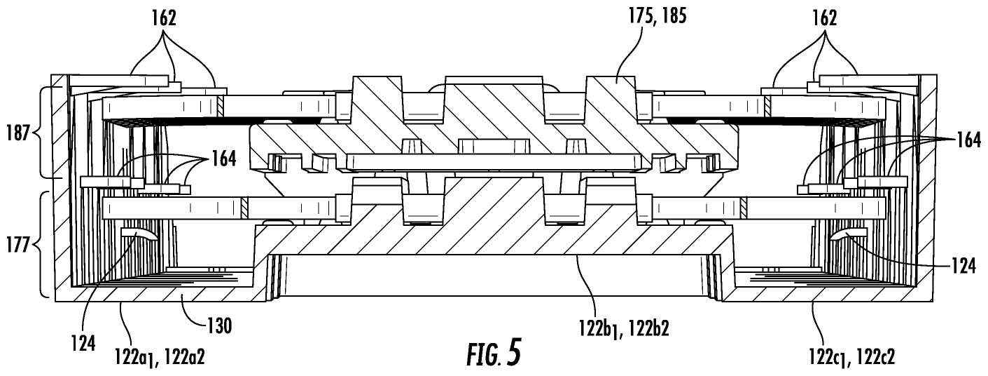

Extending from the inner periphery of each wall section 118a, 11b, 118c is a plurality of fingers/tabs 162, 164 positioned vertically along the height of the side wall 118. Upper tabs 162 extend from an uppermost edge 118d of the side wall 118 toward where the fiber is located upon complete assembly of the splice organizer tray 100 with the cables or cable subunits 2, 4. Lower tabs 164 also extend from the sidewall, but are positioned at a level that aligns with the lower vertical zone 177, as will be further described with reference to. FIGS. 4 and 5.

Referring to FIGS. 2, 4 and 5, the base 112 further includes an interconnection area or organizer floor 130, which extends between wall sections 118a, 118b. The organizer floor 130 includes bottommost floor sections 122a1, 122c1 and raised floor sections 122b1, 122b2 positioned between the bottommost floor sections 122a, 122c. The organizer floor 130 acts as an interconnection area along the splice organizer tray, by providing a series of connection areas 132 and a fiber routing area 140 around the interior periphery of the tray body 110.

As shown particularly in FIG. 2, defined in each raised floor section 122b1, 122b2 is a shallow channel 134a, 134b defined by a channel lip 136a, 136b and retention tabs 138a, 138b, which surround the periphery of each raised floor section 122b1, 122b2.

The organizer floor 130 can accommodate a variety of cable connection devices such as optical fiber splices (e.g. mechanical splices, fusion splices, mass fusion splices or mass mechanical splices) and optical connector adapters as well as optical splitters. The splices can be disposed in conventional splice inserts; the optical splitter can be disposed in an optical splitter holder and the optical fiber adapter can be held in a modular adapter plate. In an exemplary aspect, the interconnection area can include a first interconnection layer disposed on a base of the splice organizer tray, and a second interconnection layer positioned over at least a portion of the first interconnection layer.

The splice organizer tray 100 includes multiple fiber zones—specifically horizontal and vertical zones—with each fiber zone being designed to allow the end user adequate flexibility for fiber interconnection, storage, and fiber routing.

To further define the respective zones, the splice organizer tray 100 includes a divider 150, which extends upwardly from the base 112 of the tray body 110 to divide the organizer floor 130 into two horizontal fiber zones 130a, 130b. The divider 150 is also configured to provide a fiber crossover point, which is centrally located in the splice organizer tray. The divider 150 preferably includes two end divider portions 150a, 150b, a divider medial portion 150c, and routing portions 152a, 152b configured to provide guiding features, e.g. when one or more fibers need to change the direction they are wrapped in the splice organizer tray.

A first horizontal fiber zone 130a is disposed between the first end 114a of the splice organizer tray 100 and the divider 150. In preferred embodiments, a forward end zone element 154 further defines the first horizontal fiber zone 130a. The forward end zone element 154 is preferably coupled to the base 112 and includes at least two upper binding portions 156a. 156b and a zone binding portion 158 that attaches to the base 112 and each upper binding portion 156a. 156b. More preferably, the zone binding portion 158 has a curved profile for positioning of fiber with an appropriate bend radius, as particularly shown in FIGS. 1A-1B. A second horizontal fiber zone 130b is disposed between the divider 150 and the second end 114b of the splice organizer tray 100. The second horizontal fiber zone 130b is bounded by the curved wall 118c and rearward end zone elements 157.

In an exemplary aspect, the splice organizer tray 100 includes a plurality of optical component inserts 170, 180, each of which is secured to the base 112 of the splice organizer tray 100. A first optical component insert 170 can be secured to the base of the splice organizer tray 100 to create the first interconnection layer 135 and a second optical component insert 180 can be secured the base 112 of the splice organizer tray 100 to create the second interconnection layer 145. In the exemplary embodiment, the first optical component insert 170 is disposed on the raised floor section, and the second optical component insert 180 is disposed on the raised floor section 122b2 (FIG. 2).

Each of the optical component inserts holds a plurality of optical components (not shown). Each optical component insert 170, 180 can be secured to the base by an adhesive, such as a piece of double sided tape or a transfer adhesive, or by engaging with insert catches 171 (FIG. 2) disposed in the organizer floor 130.

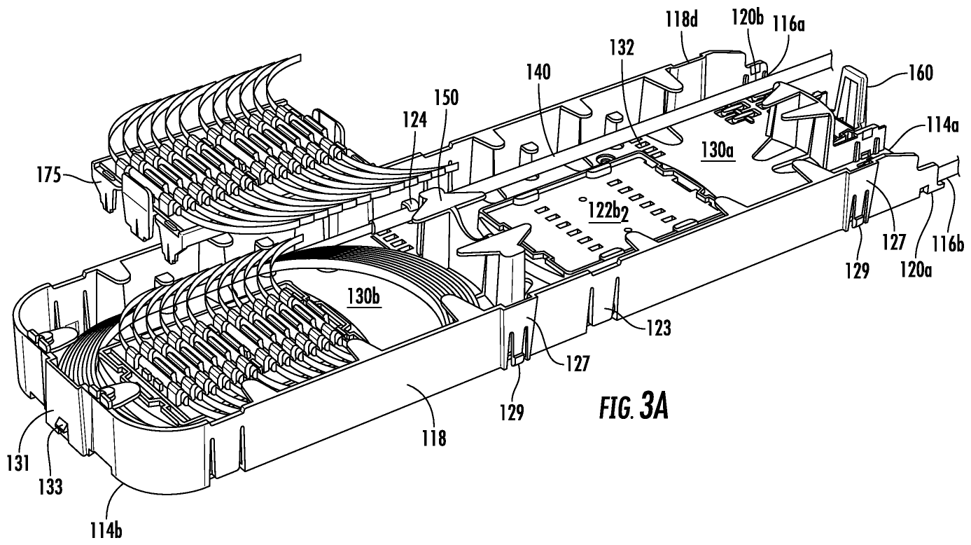

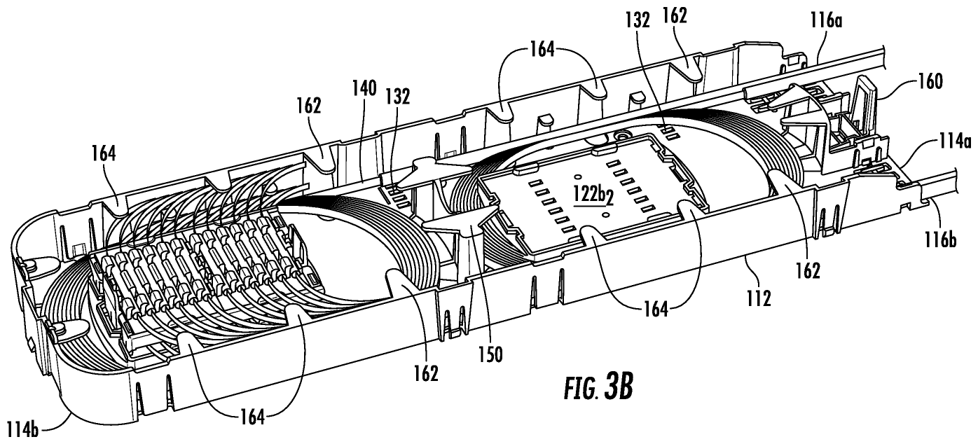

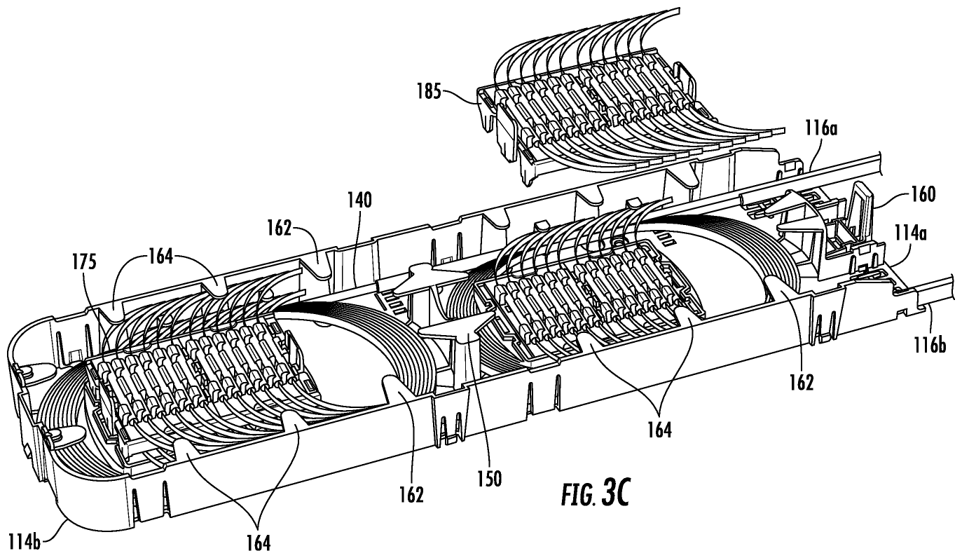

FIGS. 3A-3C, show in preferred configurations, how repositionable mezzanines 175, 185 are configured for positioning above their respective optical component inserts 170, 180. Utilizing the repositionable mezzanine allows splice inserts, for example, to be stacked, essentially multiplying the interconnection density (e.g. splice count) for a given amount of area in the splice organizer tray 100. For example ribbonized fiber having up to 144 fibers are capable of being grouped, its slack stored and spliced in lower vertical zones, while remaining ribbonized fibers are grouped, stored, and spliced in an upper vertical zone. The number of zones shown in FIGS. 1A-3A, however, should not be construed as limiting and should be based upon the overall height of the tray wall.

The use of the repositionable mezzanines 175, 185 also allows for the creation of vertical fiber zones 177, 187 in the splice organizer tray 100, as shown in FIGS. 4 and 5. The vertical fiber zones 177, 187 are defined by vertically oriented tabs, which are coupled to the inner periphery of the side wall 118 of the splice organizer tray 100.

Accordingly, one method of routing, storing, and splicing fiber into a multi-zoned high capacity splice organizer tray includes the steps of:

The exemplary splice organizer tray described herein has several advantageous features. The exemplary splice organizer tray can be deeper than conventional trays without compromising on interconnection density enabling storage of larger amounts of fiber, including ribbonized optical fibers. The divider provides an optical fiber crossover channel that increases the flexibility of fiber routing in the splice organizer tray. The repositionable mezzanines enables the elevation of optical component inserts providing increased connection capacity. The exemplary splice organizer tray is also compatible with a number of auxiliary components including optical splitter inserts, optical fiber fanouts, and optical fiber connector adapter patch field.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A multi-zoned, high-capacity splice organizer tray, comprising:
a tray body, having a base that extends longitudinally from a first end to a second end, wherein the base includes a plurality of cable entrances at the first end,
a first interconnection layer disposed on the base, comprising a first optical component insert and a first repositionable mezzanine,
a second interconnection layer substantially aligned horizontally with the first interconnection layer, the second interconnection layer comprising a second optical component insert and a second repositionable mezzanine;
wherein defined in the splice organizer tray is a plurality of horizontal fiber zones for storage of fiber optic cables routed through the plurality of cable entrances, wherein each horizontal fiber zone is bounded by a divider; and
wherein defined in the splice organizer tray is a plurality of vertical fiber zones, and wherein each vertical fiber zone is bounded by a plurality of vertically oriented tabs arranged at different heights along a side wall of the splice organizer tray.

2. The splice organizer tray of claim 1, wherein each optical component insert is disposed within a shallow channel formed in the base wherein each of the plurality of optical component inserts is configured to hold a first plurality of optical components.

3. The splice organizer tray of claim 1, wherein each repositionable mezzanine comprises a generally rectangular panel and a plurality of legs extending downwardly to couple with the base.

4. The splice organizer tray of claim 3, wherein the base comprises a plurality of catches to couple with each optical component insert.

5. The splice organizer tray of claim 2, wherein each optical component insert can be selected from the group consisting of optical splitters, mass fusion splices, single fusion splices, multifiber mechanical splices and mechanical splices.

6. The splice organizer tray of claim 1, wherein each optical component insert is configured to hold fusion splices.

7. The splice organizer tray of claim 1, wherein each optical component insert is configured to hold mechanical splices.

8. The splice organizer tray of claim 1, further comprising a latch disposed on the first end of the base, wherein a connection mechanism is configured to connect the splice organizer tray to at least a second splice organizer tray.

9. The splice organizer tray of claim 1, wherein the splice organizer tray further comprises a side wall extending from the base from a first corner at the first end of the base around the second end of the base to a second corner at the first end of the base.
